(19) United States
(12) Patent Application Publication
(10) Pub. No.: US 2016/0184829 A1
(43) Pub. Date: Jun. 30, 2016

(54) NUCLEIC ACID AMPLIFICATION APPARATUS AND SYSTEM

(71) Applicant: Ibis Biosciences, Inc., Carlsbad, CA (US)

(72) Inventors: Thomas N. Chiesl, Carlsbad, CA (US); Steven G. Haupt, Carlsbad, CA (US)

(21) Appl. No.: 14/920,675

(22) Filed: Oct. 22, 2015

Related U.S. Application Data
(60) Provisional application No. 62/067,258, filed on Oct. 22, 2014.

(51) Int. Cl. B01L 7/00; G01N 35/00

(52) U.S. Cl. CPC B01L 7/52; G01N 35/00029; B01L 2300/1822; B01L 2300/1894; B01L 2300/1805; G01N 2035/00376; G01N 2035/00366; G01N 2035/00148

(57) ABSTRACT

This present disclosure relates to devices, systems, and methods for performing biological assays. In particular, the present disclosure provides microfluidic devices, systems, and methods for performing fast amplification reactions.

### CROSS-REFERENCE TO RELATED APPLICATIONS

The present Application claims priority to U.S. Provisional Application Ser. No. 62/067,258 filed Oct. 22, 2014, the entirety of which is incorporated by reference herein.

### FIELD OF THE INVENTION

This present disclosure relates to devices, systems, and methods for performing biological assays. In particular, the present disclosure provides microfluidic devices, systems, and methods for performing fast amplification reactions.

### BACKGROUND OF THE INVENTION

Nucleic acid amplification reactions are crucial for many research, medical, and industrial applications. Such reactions are used in clinical and biological research, detection and monitoring of infectious diseases, detection of mutations, detection of cancer markers, environmental monitoring, genetic identification, detection of pathogens in biodefense applications, and the like, e.g. Schweitzer et al., Current Opinion in Biotechnology, 12: 21-27 (2001); Koch, Nature Reviews Drug Discovery, 3: 749-761 (2004). In particular, polymerase chain reactions (PCRs) have found applications in all of these areas, including applications for viral and bacterial detection, viral load monitoring, detection of rare and/or difficult-to-culture pathogens, rapid detection of bio-terror threats, detection of minimal residual disease in cancer patients, food pathogen testing, blood supply screening, and the like, e.g. Mackay, Clin. Microbiol. Infect., 10: 190-212 (2004); Bernard et al., Clinical Chemistry, 48: 1178-1185 (2002). In regard to PCR, key reasons for such widespread use are its speed and ease of use (typically performed within a few hours using standardized kits and relatively simple and low cost instruments), its sensitivity (often a few tens of copies of a target sequence in a sample can be detected), and its robustness (poor quality samples or preserved samples, such as forensic samples or fixed tissue samples are readily analyzed), Strachan and Read, Human Molecular Genetics 2 (John Wiley & Sons, New York, 1999).

Despite the advances in nucleic acid amplification techniques that are reflected in such widespread applications, there is still a need for further improvements in speed and sensitivity, particularly in such areas as infectious disease detection, minimum residual disease detection, bio-defense applications, and the like.

### SUMMARY OF THE INVENTION

This present disclosure relates to devices, systems, and methods for performing biological assays. In particular, the present disclosure provides microfluidic devices, systems, and methods for performing fast biochemical (e.g., amplification) reactions.

For example, in some embodiments, the present disclosure provides a device for performing biochemical assays, comprising one or more (e.g., all) of: a) a spring loaded thermal electric cooler (TEC) subassembly; b) a heat spreader; c) a local signal boosting electronic circuit d) a secondary thermal reservoir; and e) a flexible conductive material that connects the TEC subassembly to the secondary thermal reservoir. In some embodiments, the TEC subassembly comprises one or more of a Peltier element, a heat spreader with thermistor insert, a thermistor, a thermal reservoir, a protecting collar, a spring or ball plunger, a mounting bracket, or a temperature measurement signal booster circuit board. In some embodiments, the thermal reservoir is constructed from a heat conducting material (e.g., metals such as aluminum, steel, brass, iron, lead, or copper). In some embodiments, the spring is inserted into a hole in the thermal reservoir. In some embodiments, the spring pushes the Peltier element away from the bracket. In some embodiments, the heat spreader is constructed from a heat conducting material (e.g., metals such as aluminum, steel, brass, iron, lead, or copper). In some embodiments, the heat spreader is modified with gold or silver plating. In some embodiments, the heat spreader comprises a cutout. In some embodiments, a thermistor is placed in the cutout. In some embodiments, the flexible conductive material is a copper wire or strap.

Further embodiments provide a system, comprising any of the aforementioned devices and a microfluidics cartridge in operable communication with the device. In some embodiments, the system comprises two of the devices and the microfluidics card is sandwiched between the two devices. In some embodiments, the microfluidics card comprises one or more reaction chambers for performing a biochemical reaction (e.g., an amplification reaction, a sequencing reaction, and a hybridization reaction). In some embodiments, the microfluidics card is sealed with a biocompatible adhesive. In some embodiments, systems further comprise software and a computer processor, and a user interface (e.g., display screen), wherein the software is configured to run the device. In some embodiments, the software is configured to dynamically alter the temperature of the portion of the device in communication with the microfluidics card during an amplification reaction. In some embodiments, the software is configured to perform a thermocycling reaction (e.g., fast PCR or fast RT-PCR).

Additional embodiments provide a method of performing a biochemical reaction, comprising contacting the system described herein with reagents for performing a biochemical reaction, and altering the temperature of the reaction using the device (e.g., by transferring heat to and from the thermal reservoir and secondary thermal reservoir). In some embodiments, the reaction is an amplification reaction and the device thermocycles the temperature. In some embodiments, the device maintains a higher or lower set point than the desired set point. In some embodiments, the device dynamically changes the set point to reach the target temperature. In some embodiments, the reaction is a diagnostic or screening assay. For example, in some embodiments, the diagnostic assay identifies nucleic acid mutations or identifies microorganisms (e.g., pathogenic microorganisms).

Further embodiments provides a method of performing a biochemical reaction, comprising: a) contacting the system described herein with reagents for performing a biochemical reaction; and b) altering the temperature of the reaction using the device by maintaining a higher or lower set point than the desired set point and dynamically changing the set point to reach the target temperature.

Other embodiments provide a system, comprising the devices described herein and a microfluidics cartridge in operable communication with said device, wherein the system is configured to increase the speed or yield or decrease the background signal of a fast amplification reaction relative to a system lacking one or more components described herein.

Still other embodiments provide a system, comprising the devices described herein; a microfluidics cartridge in operable communication with said device; and computer software and a computer processor configured to alter the temperature of the reaction using the device by maintaining a higher or lower set point than the desired set point and dynamically changing the set point to reach the target temperature.

Additional embodiments are described herein.

### BRIEF DESCRIPTION OF THE FIGURES

FIG. 1 shows schematic views of a spring-load TEC subassembly used in exemplary devices of the present disclosure.

FIG. 2 shows schematic views of a microfluidic card (PCR consumable) and interface to TEC subassembly used in exemplary devices of the present disclosure.

FIG. 3 shows isolated schematic views of a heat spreader, TEC, and inserted thermistor used in exemplary devices of the present disclosure.

FIG. 4 shows (Left) schematic view of PCB board and linkage to the TEC, and thermistor used in exemplary devices of the present disclosure. (Center) protecting collar shown. (Right) protecting collar shown in transparent mode.

FIG. 5 shows a schematic of basic heat transfer principle of the TECs and PCR reactor control.

FIG. 6 shows (Left) an example of a temperature profile of a PCR cycle vs time that fails after 20 cycles due to accumulation of too much heat in the thermal reservoirs. (Center) the test assembly used for the experiment in the open position. (Right) A photograph of the test assembly closed. FIG. 7 shows (Left) a simple schematic of the heat bridge concept used in exemplary devices of the present disclosure. (Right) Thermal image of the TEC assembly with copper braid during PCR.

FIG. 8 shows (Left) a photograph of a TEC assembly without copper braid and a TEC assembly with copper braid attached to an extended thermal reservoir. (Center) thermal image of the same two systems in the photograph before PCR cycling. (Right) The same two TEC assemblies after 35 cycles of fast PCR have been performed.

FIG. 9 shows (Left) a plot of temperature vs. time. (Right) sample PCR program script using overshoot and undershoot set point temperatures to drive fast PCR reactions.

FIG. 10 shows (Left) four example scripts for fast PCR that produce different annealing temperature but have constant extension and denaturing temperatures. (Center) overlaid plots of temperature vs. time for the PCR protocols described left. (Right) electropherograms of a single-plex PCR product from protocols that have had annealing times standardized based off of the test scripts on the left.

FIG. 11 shows an electropherogram from a successful highly-multiplexed PCR reaction.

FIG. 12 shows (Left) amplitudes of amplicons produced by Fast PCR reaction systems of embodiments of the present disclosure sprayed on a mass spectrometer compared to amplicons from a standard BAD assay PCR protocol and a new a new and improved PCR protocol developed on a commercial system for 1000, 100, and 10 copies of template. (Right) mass spectra of amplicons generated from fast PCR using the invention (left spectra) and from the standard PCR (right spectra).

FIG. 13 shows a line drawing of exemplary devices of embodiments of the present disclosure. The secondary heat reservoir (13), primary heat reservoir (6), strap connecting primary to secondary reservoir (12), bracket (9), and electronics Board (10) are shown.

### DETAILED DESCRIPTION OF THE INVENTION

This present disclosure relates to devices, systems, and methods for performing fast amplification reactions. In some embodiments, the devices and systems comprise microfluidic systems and/or small hand-held instrumentation platforms.

In some embodiments, the present disclosure provides devices and system comprising one or more or all of: (1) a spring loaded thermal electric cooler (TEC) subassembly, (2) a heat spreader with integrated temperature sensor, (3) a local signal boosting electronic circuit, (4) flexible conductive materials that re-direct heat into secondary thermal reservoir(s); and (5) dynamic under- and over-shoot TEC set points that drive internal temperature changes faster. Embodiments of the present disclosure provide ultra-fast ramping of molecular biology systems such as amplification (e.g., PCR) systems at high frequencies, enables compact instrumentation design, enables lighter weight hand-held instrumentation by replacement of metal with plastic components, and ensures excellent contact between instrumentation and consumables.

I. Devices and Systems

Embodiments of the present disclosure provide devices and systems for performing rapid thermo cycling or temperature controlled biochemical assays. Exemplary devices and systems are described herein.

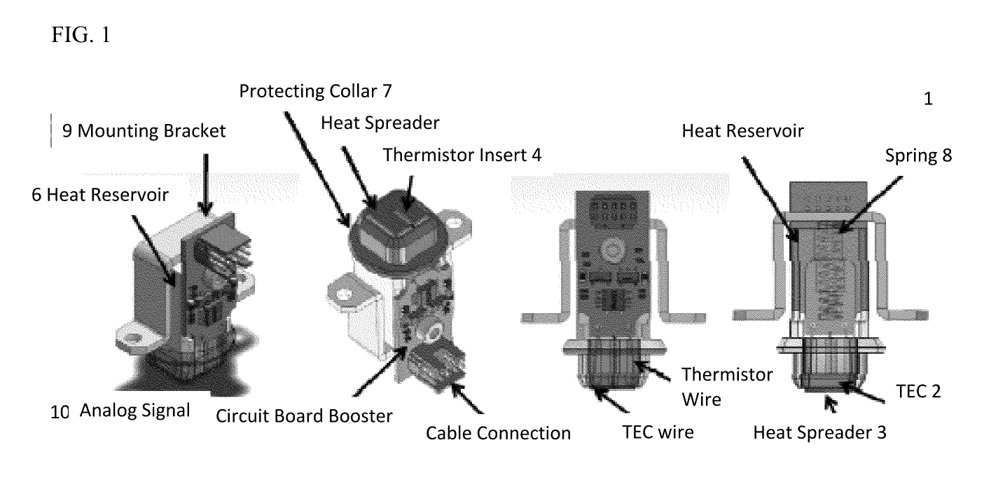

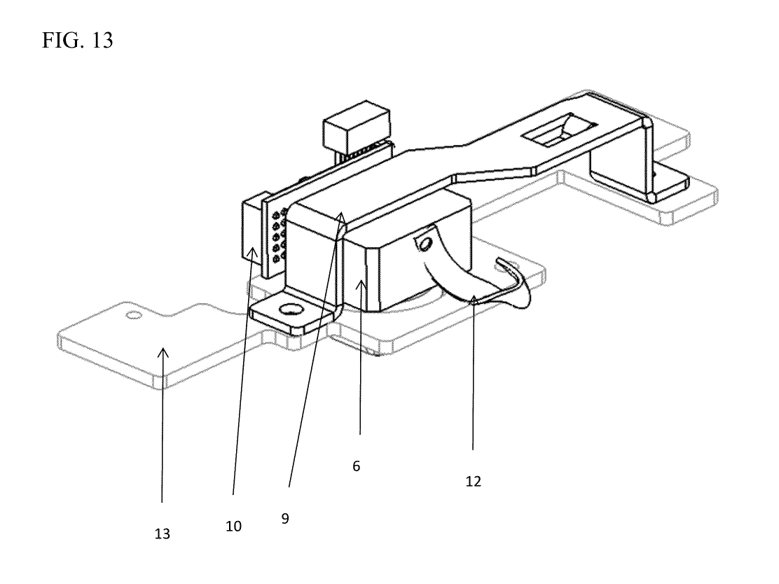

A schematic of an exemplary TEC subassembly 1 in shown in FIGS. 1 and 13. This figure shows elements for performing fast amplification. These components include, for example: the TEC itself (e.g., a Peltier element) 2, a heat spreader 3 with thermistor insert 4, a thermistor (or RTD) 5, a thermal reservoir 6, a protecting collar 7, a spring 8, a mounting bracket 9, and a temperature measurement signal booster circuit board 10. The thermal or heat reservoir 6 can be made from any heat conducting materials, including but not limited to, metals such as aluminum, steel, brass, iron, or lead. In some embodiments copper is utilized due to its high thermal mass.

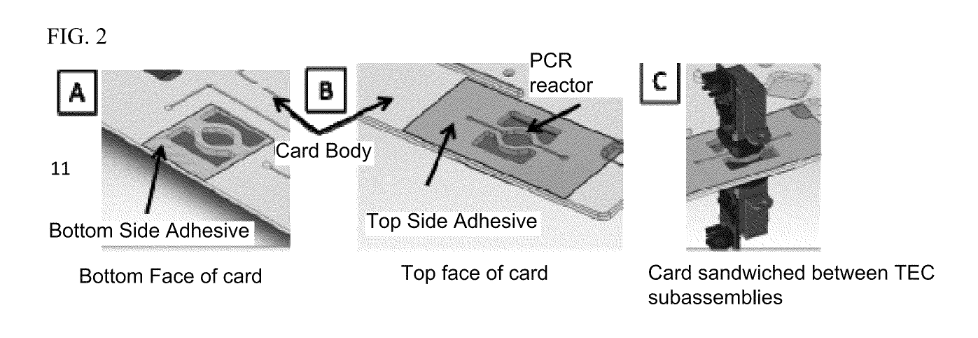

In some embodiments, the spring 8 fits into a bored-out hole 14 in the thermal reservoir 6 and pushes the TEC/Heat Spreader/Thermal reservoir components away from a bracket 9 (e.g., for mounting into an instrument) to make good contact with the reaction card as pictured in FIG. 2. The spring loaded aspect of the device allows the whole assembly to have some range of motion normal to the consumable surface (e.g., what typically is in the Z direction otherwise known as up and down, but the assembly could be rotated sideways and still work with flexibility in X or Y plane “east-west” or “north south” directions). In some embodiments, this range of motion is 0.1-100 mm, although other ranges are contemplated. In some embodiments, small levels of range of motion (e.g., 1-10 mm) allow for extra compliance amongst the consumable reaction card and the instrumentation while maintaining a high degree of tolerance. In other words the surface of the heat spreader makes good contact with the card consumable given typical thickness size differences in parts created through various manufacturing and assembly practices. This good physical contact leads to good thermal contact and improved heat transfer properties over a range of operating conditions. The use of a spring primarily limits the degree of motion to a single axis direction; however some pitch, roll, and yaw components can exist, which helps to push the system components flush with the card if the surface of the card and surface of the heat spreader are not initially parallel.

In some embodiments, the compression spring is replaced by a ball plunger. The ball plunger further restricts the movement in more of a single direction as opposed to the spring and has the advantage of assembly mounting. In some embodiments, the bored hole in the thermal reservoir is tapped (e.g., threaded) to allow for a simple screw-in ball plunger. This ball plunger also adds some thermal mass to the reservoir and increases the heat transfer from the thermal reservoir to the bracket when compared to the spring system.

A schematic of how the TECs push against an example reaction card 11 (e.g., microfluidic card) are shown in FIG. 2. The microfluidic card 11 comprises a chamber used for performing biochemical or molecular biology assays (e.g. amplification reactions such as fast PCR, reverse transcriptase, RT-PCR, qPCR, isothermal amplifications etc., sequencing assays, and hybridization assays). In some embodiments, the chamber is sealed (e.g., via biochemically compatible adhesives). The card is then inserted into an instrument. The card 11 then becomes sandwiched between the two spring loaded TEC subassemblies 1 where the bottom assembly pushes the card upwards and the top assembly pushes the card downwards. The instrument and card are designed in such a manner that compression is utilized on both springs 8 in the TEC assemblies 1 to provide a good fit for the card into the instrument appropriately. This ensures compliance and good heat transfer. Additionally, the adhesive/adhesive liner has some conformance.

Although the present disclosure is exemplified with a spring, any component that applies directional mechanical force (e.g., any elastic object that stores mechanical energy) can be utilized. Examples include, but are not limited to, tension/extension springs, compression springs, tension springs, constant tension springs, variable tension springs, coil springs, flat springs, machined springs, gas springs, wave springs, cantilever springs, balance springs, leaf springs, and or v-springs.

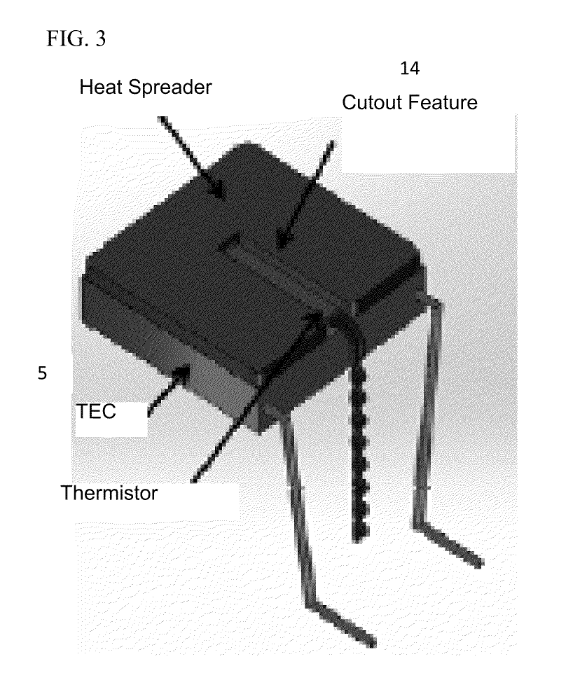

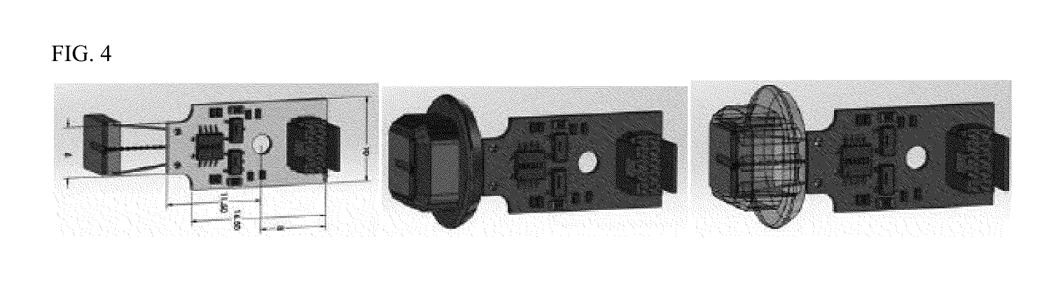

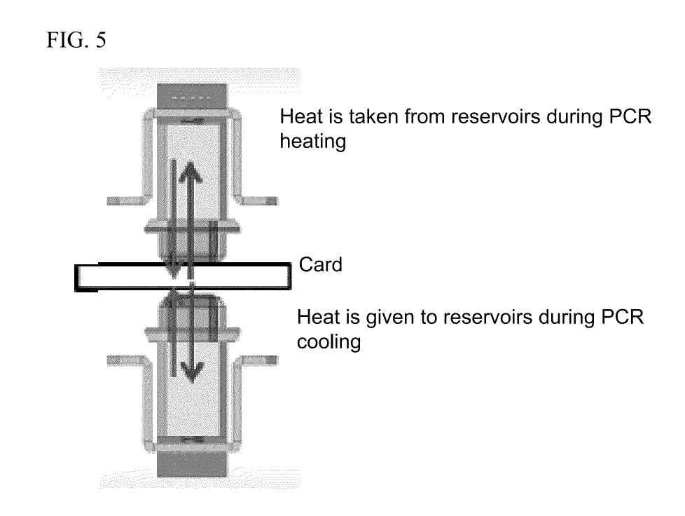

The heat spreader 3 is shown in FIG. 3. In some embodiments, the heat spreader 3 is larger or smaller than the TEC 1 itself to apply heat to a focused or broader area of interest. In some embodiments, the heat spreader 3 is made of a highly conductive material (e.g. aluminum or copper) and is optionally surface modified (e.g., gold or silver plated) to help prevent corrosion and oxidation while maintaining good thermal properties.

In some embodiments, the heat spreader includes a cutout 14 created by water jetting or other machining methods or metal injection molding. The cutout allows for a thermistor 5 to be placed and bonded inside of the heat spreader 3 such that the thermistor 5 makes a temperature measurement of the heat spreader. The heat spreader 3 comprises dimensions that provide a uniform temperature throughout during operation. The temperature that a thermistor 5 measures is consistent throughout the heat spreader 3 and minute differences in placement of the thermistor 5 are inconsequential. The combination of the heat spreader 3/thermistor 5 allows for a direct measurement of temperature on/in the spreader and is then used to give feedback control to the TEC driving boards. The TEC 1 itself does not measure/report temperature. Standard control algorithms (e.g., PI, PID, cascade) are then used to control temperature in the heat spreader and thus indirectly controls the temperature inside the reaction chamber.

Thermistors/RTDs typically generate very small signals which can be subject to radio/electronic noise interference. In some embodiments, the board limits the potential for interference by placing the wiring a short distance (e.g., 5 cm or less, 4 cm or less, 3 cm or less, 2 cm or less, or 1 cm or less) from the signal processing on the electronics board 10. The primary function of this board is to take the small signal generated from the thermistor 5 or RTD circuit and amplify/strengthen the signal such that it is no longer subject to interference from the outside environment or from other electronics in the instrument itself. The second aspect of this board that enables reliable rapid thermal cycling is that detrimental interface/physical interaction problems are significantly reduced and or eliminated. For instance, in some embodiments, both the TEC 1 and thermistor 5 are commercial off the shelf components that have very small delicate wires. As an example, the heat spreader 3 is a 6 mm square as shown in FIG. 4. Those delicate wires are directly soldered into the board and the board is attached to the thermal reservoir, which is a rigid piece of metal. This technique gives an assembly person something relatively large to grab onto preventing stress/strain on the delicate wires during assembly and makes the manufacturing process easier. It also prevents random snags and reduces the possibility of failure during normal operation. In some embodiments, the subassembly also contains a protective collar 7 which slides over the heat spreader 3 and TEC 1. In some embodiments, the collar contains features (e.g., built in channels) that then encase the delicate wires and thus further stress and strain is prevented. The protective collar 7 also provides a degree of water/splash resistance as well and helps prevent electrical shorting.

The collar 7 is made from any suitable material including but not limited to, plastic (e.g., delrin, polypropylene, acrylic, or styrene) and/or from softer materials such as rubbers or polydimethylsiloxane (PDMS). In some embodiments, the circuit board 10 contains a built in header that then connects a simple/standard ribbon cable with standard connector (shown as a 10 pin header but could be more or less that 10). Because the output temperature signal measured from the board is now large, the length of this standard cable can be long or short for more useful instrumentation layouts. It also allows for a simple interface to a “main board” that performs control operations and provides the driving voltage and current for the TECs.

The temperature of the PCR reaction is indirectly controlled through the temperature measurement on the heat spreader 5. The temperature of the heat spreader 5 is driven by the TEC 1. TECs act as heat pumps by transferring heat into/out of the PCR reaction from a thermal reservoir (e.g., copper block). The reaction card 11 is made hotter by pumping heat from the thermal reservoir 6 into the reaction card 11 and the reaction card 11 is made cooler by pumping heat from the reaction card 11 into the thermal reservoir 6. However, the TECs are not 100% efficient and every time the TEC performs heating, cooling, or steady-state temperature control—waste heat (e.g. P=i2R) is generated, which accumulates in the thermal reservoir. TECs can maintain/ dynamically control the PCR reaction within +/−˜30° C. from the thermal reservoir. Therefore the thermal reservoir is preferably maintained at an intermediate thermal state to allow for extremely fast ramp rates (e.g. >20° C./sec) for both heating and cooling, which accomplishes temperature change utilized in biochemical reactions (e.g., the denaturing, annealing, and extension steps found in PCR).

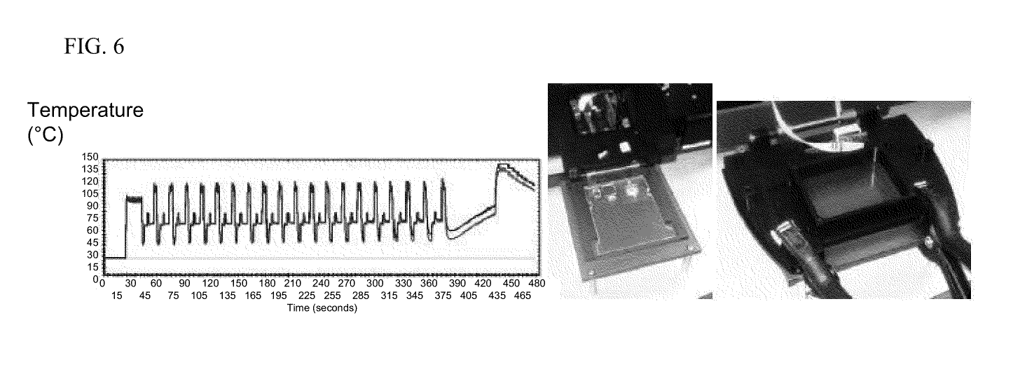

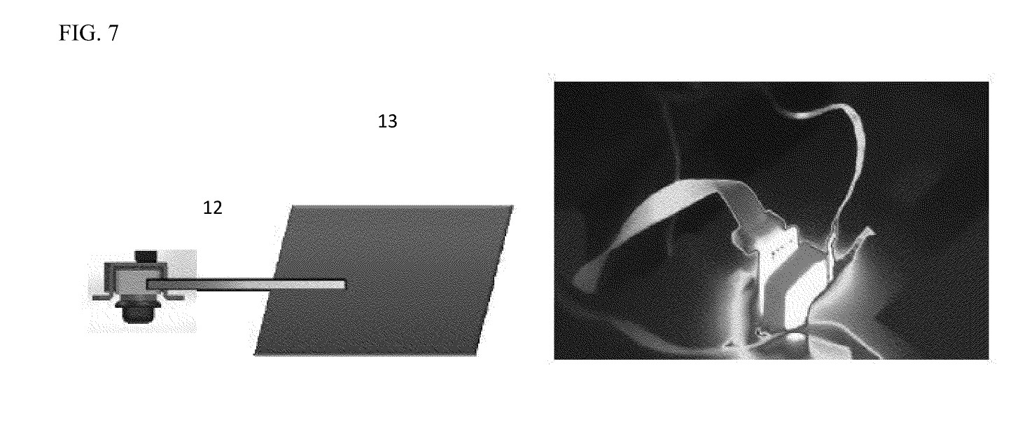

In some embodiments, in order to prevent over-heating of the thermal reservoir (See e.g., FIG. 6), passive or active temperature control components are included in devices. Active cooling is accomplished, for example, by the use of a fan(s) or another TEC system is utilized to maintain temperature. In some embodiments, a passive approach is utilized in which the size of the thermal reservoir 6 is increased or the material is changed to increase the thermal mass of the reservoir.

In some embodiments, the thermal reservoir is split into two (or more) linked components. This concept is similar to a “salt bridge” in the electrochemistry field. A smaller active reservoir 6 is connected to the TEC and a separate larger secondary reservoir 13 that acts as a waste-heat dump is utilized. In some embodiments, one or more flexible metal (e.g., copper) heat straps 12 (or a thick gauge of copper wire or graphene, or another flexible heat conductor) are used to transfer heat energy from one thermal reservoir to another larger heat reservoir. The copper straps are excellent heat conductors and remove unwanted waste heat away from the first thermal reservoir, which is connected to the TEC. In some embodiments, the larger waste-heat reservoir is a separate block of copper (or other material) designed specifically for the heat waste. In some embodiments, the secondary reservoir links to another larger thermal masses already in the system (e.g., the case or frame of the instrument or a metal pump). A schematic of using a copper strap as a heat bridge is shown in FIG. 7.

The copper strap 12 and splitting the thermal reservoir 6 into two linked sections 6 and 13 has two primary benefits. The first is that the design of the surrounding instrumentation is flexible. For example, in some embodiments, the flexible copper strap is directed to other places inside the box with ease and the large reservoir is located in any location within the instrument with ease. In addition, the main thermal reservoir is passively regulated via heat transfer laws.

In some embodiments, systems described herein use a small primary thermal reservoir 6 connected to the TEC, which provides a fast TEC response and thus fast biochemical (e.g., amplification) reactions. In addition, the secondary thermal reservoir 13 acts as the excess heat scavenger and keeps the first reservoir near optimum temperature. As the primary smaller thermal reservoir 6 becomes hotter the energy transfer through the strap 12 also increases (Q=UAΔT). This passive regulation scheme requires no actively moving parts and requires no additional power which is highly desirable for hand-held instrumentation. The flexibility in the copper strap 12 further provides the advantage of working with the spring loaded concept by moving up and down. During experiments conducted during the development of the disclosure, with the addition of the flexible copper straps 12, 120-consecutive complete fast-PCR cycles were run without failure and without pausing in between cycles. A thermal imaging photograph of the TEC subassemblies show heat flow through a copper strap (via temperature gradient) is shown in FIG. 7.

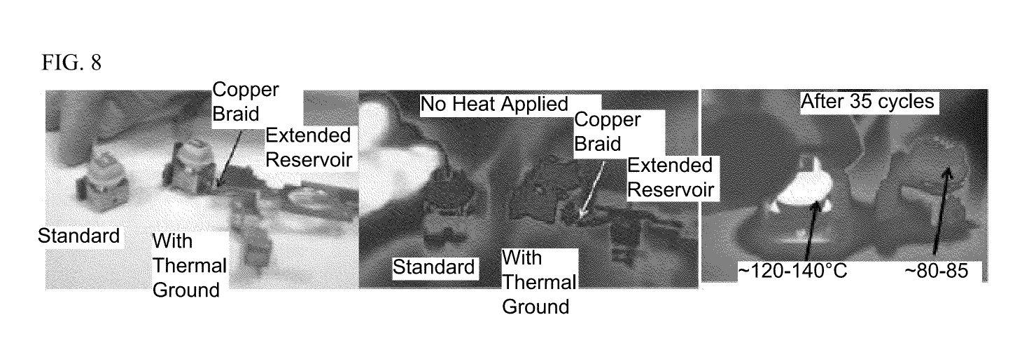

A photograph and thermal images of the TEC subassemblies with and without the copper heat traps before and during PCR are shown in FIG. 8. Before the biochemical reaction, the two assemblies have the same thermal energy; however, as a biochemical reaction occurs, the TEC assembly without the copper strap is significantly hotter compared to the TEC assembly with the copper braid. For example, in the system shown in FIG. 8, the plastic protective collar (indicated by arrows), which was ˜120-140° C. on the system without the copper braid compared to 80-85° C. on the system with the copper braid. The thermal reservoir on the system without the copper strap is also much hotter than the system with the copper braid, which indicates that the copper braid regulated the thermal reservoir and obtained proper heat management for fast PCR.

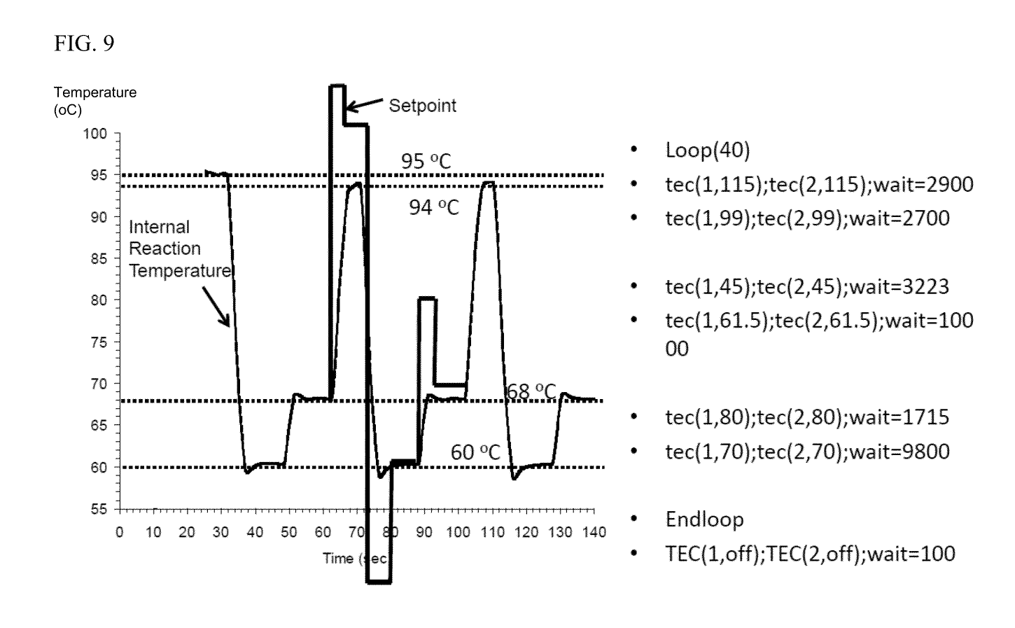

In some embodiments, devices comprise dynamic under- and over-shoot TEC set points in order to drive internal temperatures faster. Heat transfer fundamentals prescribe that an object will asymptotically approach a set point during cooling or heating. To approach within 5% of the target set point could take 1 minute; however getting within 1% of the target set point could take another 30 minutes of relative time depending on the system. To break this relationship, a solution is to use a higher set point than the true desired set point and then dynamically change it so the heated object does not overshoot the temperature and instead reaches the target temperature. This type of regulation approach is based off of principles found in PID control—more specifically cascade control scheme. For instance, when cooling from 95 to 60° C. on an MJ thermalcycler the “hot blocks” used to control temperature in the PCR reaction actually changes from 95 to 60° C. and the internal reaction temperature lags behind. In some embodiments of the present disclosure, this problem is overcome by programming a colder temperature (e.g. 45° C.) for a few seconds in fast PCR (e.g., 2 to 10 seconds, 3 to 5 seconds, or 3.2 seconds or 4.6 seconds) or for several seconds (e.g., 10-20 seconds) and then back off to 60° C. for the annealing step once the internal PCR reaction temperature reaches 60° C. An example temperature vs. time plot of this approach to achieving fast PCR is shown below in FIG. 9 along with an the script used to run the PCR program.

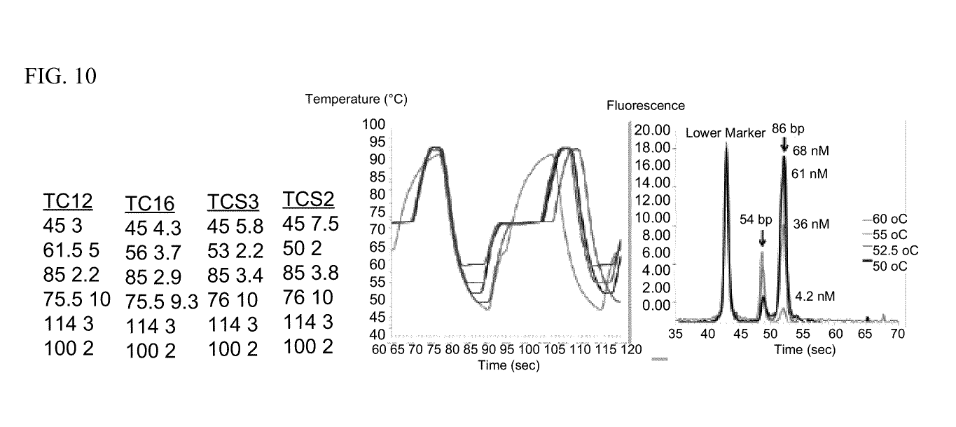

The dynamic switching of set points should be done at relatively precise timing. Once a script or program has been written to denature at 95° C. and anneal at 55° C., then that subroutine is finished. FIG. 10 shows four example scripts that have the temperature and the time in sec listed in seconds. These scripts are test programs designed to give different annealing temperatures with the same extension and denaturing temperatures. The temperature vs time results are plotted in the center portion. The scripts were successful in producing and holding an internal “soak temperature” of 60, 55, 52.5 and 50° C. respectively. A single-plex PCR experiment was performed using this system with the indicated protocols (with different annealing temperatures) to produce a desired 86 base pair product and an undesired 54 base pair. In this experiment, the coldest annealing temperature of 50° C. and the 52.5° C. protocol yielded the most amount of total product and least amount of byproduct.

The system(s) described herein were validated on a multitude of primer pairs for multiple types of assays. The system was validated up to a 24-plex PCR assay with positive results.

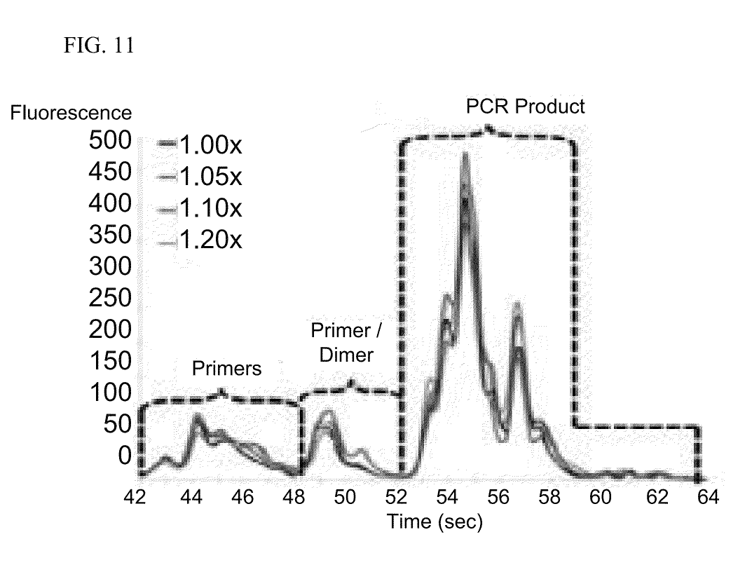

Shown below in FIG. 11 is an electropherogram for a >15-plex PCR amplification. Ample product was produced for successful assays and in this case the different traces represent various concentrations of rehydrated lyophilized master mix.

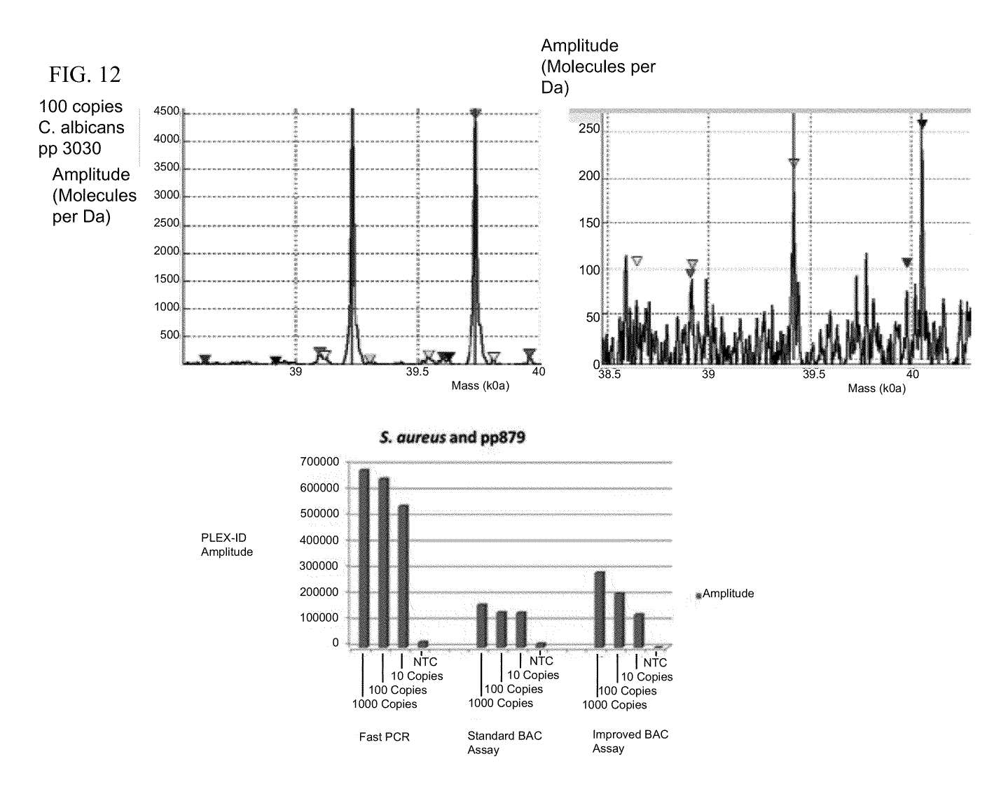

Experiments were conducted with a variety of primer pairs with very positive results. The devices of embodiments of the present disclosure produced as much or more PCR product compared to the “gold standard” commercial thermalcyclers as shown in FIG. 12. The total PCR time was 15-20 minutes compared to approximately 2 hours and 20 minutes on the commercial platform. Both the analysis performed with the fast PCR system of the present disclosure and the commercial system were completed in the presence of 15 micrograms of human DNA background. This level is representative of patient samples that are experiencing a high degree of infection (e.g. sepsis). This shows the robustness and specificity of the fast PCR. FIG. 12 also shows mass spectra data for a separate experiment in which primers were designed to amplify DNA from C. albicans. The fast PCR system of embodiments of the present disclosure produced a very high signal to noise ratio.

The devices, systems, and methods of embodiments of the present disclosure provide small, low cost solutions for performing rapid biochemical assays. Such devices, systems, and methods find use in a variety of uses. Examples include, but are not limited to, research and diagnostic applications in medicine applications, use in clinics, first responders, and the military.

In some embodiments, a software or computer programs is provided (e.g., as part of a system comprising the devices described herein or as a stand-alone product). In some embodiments, software runs the devices described herein and/or analyses data generated using the devices described herein. For example, in some embodiments, software comprises algorithms for running fast-PCR reactions, displaying results, and analyzing data. For example, in some embodiments, software is configured to control heating and cooling steps and manage set points using the devices described herein. For example in some embodiments, software is configured to alter the temperature of the reaction using the device by maintaining a higher or lower set point than the desired set point and dynamically changing the set point to reach the target temperature.

In some embodiments, PCR algorithms and/or results are displayed on user interface (e.g., a display screen). In some embodiments, software is run on a computer, tablet, or smart phone.

II. Methods

The devices and systems described herein find use in a variety of research, screening, and diagnostic methods. Examples include, but are not limited to, sample preparation, mutation or polymorphism identification, and identification and characterization of microorganisms (e.g., pathogenic microorganisms).

In some embodiments, the devices and systems described herein find use in amplification reactions. Illustrative non-limiting examples of nucleic acid amplification techniques include, but are not limited to, polymerase chain reaction (PCR), reverse transcription polymerase chain reaction (RT-PCR), transcription-mediated amplification (TMA), ligase chain reaction (LCR), strand displacement amplification (SDA), qPCR, isothermal PCR, and nucleic acid sequence based amplification (NASBA). Those of ordinary skill in the art will recognize that certain amplification techniques (e.g., PCR) require that RNA be reversed transcribed to DNA prior to amplification (e.g., RT-PCR), whereas other amplification techniques directly amplify RNA (e.g., TMA and NASBA).

In some embodiments, the devices and systems described herein find use sequencing methods. Examples include, for example, chain terminator (Sanger) sequencing, dye terminator sequencing, and high-throughput sequencing methods. Many of these sequencing methods are well known in the art. See, e.g., Sanger et al., Proc. Natl. Acad. Sci. USA 74:5463-5467 (1997); Maxam et al., Proc. Natl. Acad. Sci. USA 74:560-564 (1977); Drmanac, et al., Nat. Biotechnol. 16:54-58 (1998); Kato, Int. J. Clin. Exp. Med. 2:193-202 (2009); Ronaghi et al., Anal. Biochem. 242:84-89 (1996); Margulies et al., Nature 437:376-380 (2005); Ruparel et al., Proc. Natl. Acad. Sci. USA 102:5932-5937 (2005), and Harris et al., Science 320:106-109 (2008); Levene et al., Science 299:682-686 (2003); Korlach et al., Proc. Natl. Acad. Sci. USA 105:1176-1181 (2008); Branton et al., Nat. Biotechnol. 26 (10):1146-53 (2008); Eid et al., Science 323:133-138 (2009); each of which is herein incorporated by reference in its entirety.

Next-generation sequencing (NGS) methods share the common feature of massively parallel, high-throughput strategies, with the goal of lower costs in comparison to older sequencing methods (see, e.g., Voelkerding et al., Clinical Chem., 55: 641-658, 2009; MacLean et al., Nature Rev. Microbiol., 7: 287-296; each herein incorporated by reference in their entirety). NGS methods can be broadly divided into those that typically use template amplification and those that do not. Amplification-requiring methods include pyrosequencing commercialized by Roche as the 454 technology platforms (e.g., GS 20 and GS FLX), the Solexa platform commercialized by Illumina, and the Supported Oligonucleotide Ligation and Detection (SOLiD) platform commercialized by Applied Biosystems. Non-amplification approaches, also known as single-molecule sequencing, are exemplified by the HeliScope platform commercialized by Helicos BioSciences, and emerging platforms commercialized by VisiGen, Oxford Nanopore Technologies Ltd., Life Technologies/Ion Torrent, and Pacific Biosciences, respectively.

In pyrosequencing (Voelkerding et al., Clinical Chem., 55: 641-658, 2009; MacLean et al., Nature Rev. Microbiol., 7: 287-296; U.S. Pat. No. 6,210,891; U.S. Pat. No. 6,258,568; each herein incorporated by reference in its entirety), template DNA is fragmented, end-repaired, ligated to adaptors, and clonally amplified in-situ by capturing single template molecules with beads bearing oligonucleotides complementary to the adaptors. Each bead bearing a single template type is compartmentalized into a water-in-oil microvesicle, and the template is clonally amplified using a technique referred to as emulsion PCR. The emulsion is disrupted after amplification and beads are deposited into individual wells of a picotitre plate functioning as a flow cell during the sequencing reactions. Ordered, iterative introduction of each of the four dNTP reagents occurs in the flow cell in the presence of sequencing enzymes and luminescent reporter such as luciferase. In the event that an appropriate dNTP is added to the 3′ end of the sequencing primer, the resulting production of ATP causes a burst of luminescence within the well, which is recorded using a CCD camera. It is possible to achieve read lengths greater than or equal to 400 bases, and 10⁶ sequence reads can be achieved, resulting in up to 500 million base pairs (Mb) of sequence.

In the Solexa/Illumina platform (Voelkerding et al., Clinical Chem., 55: 641-658, 2009; MacLean et al., Nature Rev. Microbiol., 7: 287-296; U.S. Pat. No. 6,833,246; U.S. Pat. No. 7,115,400; U.S. Pat. No. 6,969,488; each herein incorporated by reference in its entirety), sequencing data are produced in the form of shorter-length reads. In this method, single-stranded fragmented DNA is end-repaired to generate 5′-phosphorylated blunt ends, followed by Klenow-mediated addition of a single A base to the 3′ end of the fragments. A-addition facilitates addition of T-overhang adaptor oligonucleotides, which are subsequently used to capture the template-adaptor molecules on the surface of a flow cell that is studded with oligonucleotide anchors. The anchor is used as a PCR primer, but because of the length of the template and its proximity to other nearby anchor oligonucleotides, extension by PCR results in the “arching over” of the molecule to hybridize with an adjacent anchor oligonucleotide to form a bridge structure on the surface of the flow cell. These loops of DNA are denatured and cleaved. Forward strands are then sequenced with reversible dye terminators. The sequence of incorporated nucleotides is determined by detection of post-incorporation fluorescence, with each fluor and block removed prior to the next cycle of dNTP addition. Sequence read length ranges from 36 nucleotides to over 250 nucleotides, with overall output exceeding 1 billion nucleotide pairs per analytical run.

Sequencing nucleic acid molecules using SOLiD technology (Voelkerding et al., Clinical Chem., 55: 641-658, 2009; MacLean et al., Nature Rev. Microbiol., 7: 287-296; U.S. Pat. No. 5,912,148; U.S. Pat. No. 6,130,073; each herein incorporated by reference in their entirety) also involves fragmentation of the template, ligation to oligonucleotide adaptors, attachment to beads, and clonal amplification by emulsion PCR. Following this, beads bearing template are immobilized on a derivatized surface of a glass flow-cell, and a primer complementary to the adaptor oligonucleotide is annealed. However, rather than utilizing this primer for 3′ extension, it is instead used to provide a 5′ phosphate group for ligation to interrogation probes containing two probe-specific bases followed by 6 degenerate bases and one of four fluorescent labels. In the SOLiD system, interrogation probes have 16 possible combinations of the two bases at the 3′ end of each probe, and one of four fluors at the 5′ end. Fluor color, and thus identity of each probe, corresponds to specified color-space coding schemes. Multiple rounds (usually 7) of probe annealing, ligation, and fluor detection are followed by denaturation, and then a second round of sequencing using a primer that is offset by one base relative to the initial primer. In this manner, the template sequence can be computationally re-constructed, and template bases are interrogated twice, resulting in increased accuracy. Sequence read length averages 35 nucleotides, and overall output exceeds 4 billion bases per sequencing run.

In certain embodiments, nanopore sequencing (see, e.g., Astier et al., J. Am. Chem. Soc. 2006 Feb. 8; 128 (5):1705-10, herein incorporated by reference) is utilized. The theory behind nanopore sequencing has to do with what occurs when a nanopore is immersed in a conducting fluid and a potential (voltage) is applied across it. Under these conditions a slight electric current due to conduction of ions through the nanopore can be observed, and the amount of current is exceedingly sensitive to the size of the nanopore. As each base of a nucleic acid passes through the nanopore, this causes a change in the magnitude of the current through the nanopore that is distinct for each of the four bases, thereby allowing the sequence of the DNA molecule to be determined.

In certain embodiments, HeliScope by Helicos BioSciences (Voelkerding et al., Clinical Chem., 55: 641-658, 2009; MacLean et al., Nature Rev. Microbiol., 7: 287-296; U.S. Pat. No. 7,169,560; U.S. Pat. No. 7,282,337; U.S. Pat. No. 7,482,120; U.S. Pat. No. 7,501,245; U.S. Pat. No. 6,818,395; U.S. Pat. No. 6,911,345; U.S. Pat. No. 7,501,245; each herein incorporated by reference in their entirety) is utilized. Template DNA is fragmented and polyadenylated at the 3′ end, with the final adenosine bearing a fluorescent label. Denatured polyadenylated template fragments are ligated to poly(dT) oligonucleotides on the surface of a flow cell. Initial physical locations of captured template molecules are recorded by a CCD camera, and then label is cleaved and washed away. Sequencing is achieved by addition of polymerase and serial addition of fluorescently-labeled dNTP reagents. Incorporation events result in fluor signal corresponding to the dNTP, and signal is captured by a CCD camera before each round of dNTP addition. Sequence read length ranges from 25-50 nucleotides, with overall output exceeding 1 billion nucleotide pairs per analytical run.

The Ion Torrent technology is a method of DNA sequencing based on the detection of hydrogen ions that are released during the polymerization of DNA (see, e.g., Science 327 (5970): 1190 (2010); U.S. Pat. Appl. Pub. Nos. 20090026082, 20090127589, 20100301398, 20100197507, 20100188073, and 20100137143, incorporated by reference in their entireties for all purposes). A microwell contains a template DNA strand to be sequenced. Beneath the layer of microwells is a hypersensitive ISFET ion sensor. All layers are contained within a CMOS semiconductor chip, similar to that used in the electronics industry. When a dNTP is incorporated into the growing complementary strand a hydrogen ion is released, which triggers a hypersensitive ion sensor. If homopolymer repeats are present in the template sequence, multiple dNTP molecules will be incorporated in a single cycle. This leads to a corresponding number of released hydrogens and a proportionally higher electronic signal. This technology differs from other sequencing technologies in that no modified nucleotides or optics are used. The per-base accuracy of the Ion Torrent sequencer is ˜99.6% for 50 base reads, with ˜100 Mb to 100 Gb generated per run. The read-length is 100-300 base pairs. The accuracy for homopolymer repeats of 5 repeats in length is ˜98%. The benefits of ion semiconductor sequencing are rapid sequencing speed and low upfront and operating costs.

Stratos Genomics, Inc. sequencing involves the use of Xpandomers. This sequencing process typically includes providing a daughter strand produced by a template-directed synthesis. The daughter strand generally includes a plurality of subunits coupled in a sequence corresponding to a contiguous nucleotide sequence of all or a portion of a target nucleic acid in which the individual subunits comprise a tether, at least one probe or nucleobase residue, and at least one selectively cleavable bond. The selectively cleavable bond(s) is/are cleaved to yield an Xpandomer of a length longer than the plurality of the subunits of the daughter strand. The Xpandomer typically includes the tethers and reporter elements for parsing genetic information in a sequence corresponding to the contiguous nucleotide sequence of all or a portion of the target nucleic acid. Reporter elements of the Xpandomer are then detected. Additional details relating to Xpandomer-based approaches are described in, for example, U.S. Pat. Pub No. 20090035777, entitled “High Throughput Nucleic Acid Sequencing by Expansion,” filed Jun. 19, 2008, which is incorporated herein in its entirety.

Other emerging single molecule sequencing methods include real-time sequencing by synthesis using a VisiGen platform (Voelkerding et al., Clinical Chem., 55: 641-58, 2009; U.S. Pat. No. 7,329,492; U.S. patent application Ser. No. 11/671,956; U.S. patent application Ser. No. 11/781,166; each herein incorporated by reference in their entirety) in which immobilized, primed DNA template is subjected to strand extension using a fluorescently-modified polymerase and florescent acceptor molecules, resulting in detectible fluorescence resonance energy transfer (FRET) upon nucleotide addition.

In some embodiments, the devices and systems described herein find use in hybridization assays. Illustrative non-limiting examples of nucleic acid hybridization techniques include, but are not limited to, in situ hybridization (ISH), microarray, and Southern or Northern blot.

In situ hybridization (ISH) is a type of hybridization that uses a labeled complementary DNA or RNA strand as a probe to localize a specific DNA or RNA sequence in a portion or section of tissue (in situ), or, if the tissue is small enough, the entire tissue (whole mount ISH). DNA ISH can be used to determine the structure of chromosomes. RNA ISH is used to measure and localize mRNAs and other transcripts within tissue sections or whole mounts. Sample cells and tissues are usually treated to fix the target transcripts in place and to increase access of the probe. The probe hybridizes to the target sequence at elevated temperature, and then the excess probe is washed away. The probe that was labeled with either radio-, fluorescent- or antigen-labeled bases is localized and quantitated in the tissue using either autoradiography, fluorescence microscopy or immunohistochemistry, respectively. ISH can also use two or more probes, labeled with radioactivity or the other non-radioactive labels, to simultaneously detect two or more transcripts.

In some embodiments, hybridization assays are microarrays including, but not limited to: DNA microarrays (e.g., cDNA microarrays and oligonucleotide microarrays); protein microarrays; tissue microarrays; transfection or cell microarrays; chemical compound microarrays; and, antibody microarrays. A DNA microarray, commonly known as gene chip, DNA chip, or biochip, is a collection of microscopic DNA spots attached to a solid surface (e.g., glass, plastic or silicon chip) forming an array for the purpose of expression profiling or monitoring expression levels for thousands of genes simultaneously. The affixed DNA segments are known as probes, thousands of which can be used in a single DNA microarray. Microarrays can be used to identify disease genes or transcripts (e.g., miRs) by comparing gene expression in disease and normal cells. Microarrays can be fabricated using a variety of technologies, including but not limiting: printing with fine-pointed pins onto glass slides; photolithography using pre-made masks; photolithography using dynamic micromirror devices; ink jet printing; or, electrochemistry on microelectrode arrays.

Southern and Northern blotting is used to detect specific DNA or RNA sequences, respectively. DNA or RNA extracted from a sample is fragmented, electrophoretically separated on a matrix gel, and transferred to a membrane filter. The filter bound DNA or RNA is subject to hybridization with a labeled probe complementary to the sequence of interest. Hybridized probe bound to the filter is detected. A variant of the procedure is the reverse Northern blot, in which the substrate nucleic acid that is affixed to the membrane is a collection of isolated DNA fragments and the probe is RNA extracted from a tissue and labeled.

All publications, patents, patent applications and accession numbers mentioned in the above specification are herein incorporated by reference in their entirety. Although the invention has been described in connection with specific embodiments, it should be understood that the invention as claimed should not be unduly limited to such specific embodiments. Indeed, various modifications and variations of the described compositions and methods of the invention will be apparent to those of ordinary skill in the art and are intended to be within the scope of the following claims.

1. A device for performing biochemical assays, comprising one or more of:
a) a spring loaded thermal electric cooler (TEC) subassembly;
b) a heat spreader;
c) a local signal boosting electronic circuit;
d) a secondary thermal reservoir; and
e) a flexible conductive material that connects said TEC subassembly to said secondary thermal reservoir.

2. The device of claim 1, wherein said TEC subassembly comprises a Peltier element and one or more additional components selected from a heat spreader with thermistor insert, a thermistor, a thermal reservoir, a protecting collar, a spring or ball plunger, a mounting bracket, and a temperature measurement signal booster circuit board.

3. The device of claim 2, wherein said thermal reservoir is constructed from a heat conducting material.

4. The device of claim 3, wherein said heat conducting material is selected from aluminum, steel, brass, iron, lead, and copper.

5. The device of claim 2, wherein said spring is inserted into a hole in said thermal reservoir.

6. The device of claim 5, wherein said spring pushes said Peltier element away from said bracket.

7. The device of claim 2, wherein said heat spreader is constructed from a heat conducting material.

8. The device of claim 7, wherein said heat conducting material is selected from aluminum, steel, brass, iron, lead, and copper.

9. The device of claim 2, wherein said heat spreader is modified with gold or silver plating.

10. The device of claim 2, wherein said heat spreader comprises a cutout.

11. The device of claim 10, wherein a thermistor is placed in said cutout.

12. The device of claim 1, wherein said a flexible conductive material is a copper wire.

13. The device of claim 1, wherein said device comprises all of said components.

14. A system, comprising the device of claim; and a microfluidics cartridge in operable communication with said device.

15. The system of claim 14, wherein said system comprises two of said devices and said microfluidics card is sandwiched between said two devices.

16. The system of claim 14, wherein said microfluidic card comprises one or more reaction chambers for performing a biochemical reaction.

17. The system of claim 14, wherein said biochemical reaction is selected from an amplification reaction, a sequencing reaction, and a hybridization reaction.

18. The system of claim 13, wherein said system further comprises software and a computer processor, wherein said software is configured to run said device.

19. The system of claim 18, wherein said software is configured to dynamically alter the temperature of the portion of said device in communication with said microfluidics card during an amplification reaction.

20. A method of performing a biochemical reaction, comprising contacting the system of claim 14 with reagents for performing a biochemical reaction, and altering the temperature of said reaction using said device.
